(19) United States
(12) Patent Application Publication
(10) Pub. No.: US 2025/0092825 A1
(43) Pub. Date: Mar. 20, 2025

(54) BLEED AIR DRIVEN VAPOR CYCLE SYSTEM

(71) Applicant: Rolls-Royce North American Technologies Inc., Indianapolis, IN (US)

(72) Inventors: Timothy Unton, Indianapolis, IN (US); Eric S. Donovan, Indianapolis, IN (US)

(73) Assignee: Rolls-Royce North American Technologies Inc., Indianapolis, IN (US)

(21) Appl. No.: 18/469,252

(22) Filed: Sep. 18, 2023

(51) Int. Cl. F02C 7/12; F02C 3/10; F02C 9/18

(52) U.S. Cl. CPC F02C 7/12; F02C 3/10; F02C 9/18

(57) ABSTRACT

A cooling system may comprise a vapor cycle system. The cooling system may comprise a gas turbine engine. The vapor cycle system may include a compressor, a heat exchanger downstream from the compressor, and a heat load downstream from the heat exchanger and upstream of the compressor. The cooling system may comprise a bleed air conduit. The bleed air conduit may be configured to receive bleed air from the gas turbine engine. The cooling system may comprise a bleed turbine driven by the bleed air supplied from the bleed air conduit. The bleed turbine may be configured to drive the compressor of the vapor cycle system. The compressor may be connected to a bleed turbine via a shaft. The cooling system may comprise a throttle valve to control a flow of the bleed air through the bleed air conduit.

### FEDERALLY SPONSORED RESEARCH OR DEVELOPMENT

This invention was made with government support under contract numbers FA8650-19-D-2063 and FA8650-19-F-2078 awarded by the Air Force. The government has certain rights in this invention.

### TECHNICAL FIELD

This disclosure relates to cooling systems and, in particular, to cooling systems driven by bleed air from gas turbine engines.

### BACKGROUND

Present cooling systems suffer from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a cross-sectional view of an example of a gas turbine engine;

FIG. 2 illustrates an example of a bleed air driven cooling system;

FIG. 3 illustrates an example of a bleed air driven cooling system;

FIG. 4 illustrates an example of a bleed air driven cooling system;

FIG. 5 illustrates an example of a bleed air driven cooling system; and

FIG. 6 illustrates an example of a method for cooling a heat load.

### DETAILED DESCRIPTION

A cooling system may comprise a vapor cycle system. The cooling system may comprise a gas turbine engine. The vapor cycle system may include a compressor, a heat exchanger downstream from the compressor, and a heat load downstream from the heat exchanger and upstream of the compressor. The cooling system may comprise a bleed air conduit. The bleed air conduit may be configured to receive bleed air from the gas turbine engine. The cooling system may comprise a bleed turbine driven by the bleed air supplied from the bleed air conduit. The bleed turbine may be configured to drive the compressor of the vapor cycle system. The compressor may be connected to a bleed turbine via a shaft. The cooling system may comprise a throttle valve to control a flow of the bleed air through the bleed air conduit.

A method of cooling a heat load may comprise cooling a heat load via a vapor cycle system with a cooling fluid. The method may comprise compressing the cooling fluid with a compressor of the vapor cycle system. The method may comprise rotating a bleed turbine with bleed air from a gas turbine engine. The method may comprise driving the compressor with the rotating bleed turbine.

One interesting feature of the systems and methods described below may be that, by using a vapor cycle system (VCS) driven by bleed air, more efficient cooling can be achieved without the need for a large electric motor and while using less bleed air taken from a gas turbine engine. Using a closed loop VCS may provide more efficient cooling than, for example, an air cycle system and is not as greatly affected by humidity or other ambient environment factors. Additionally, by using bleed air and a bleed turbine driven by bleed air to drive the VCS, the VCS can be driven without the need for an additional electric motor, which would add weight to system. Another interesting feature is that the system is able to utilize the same interface as an air-cycle machine, allowing for ease of installation on existing aircrafts already set up to use an air-cycle machine, but would use less bleed air flow than an air-cycle flow due to the more efficient VCS.

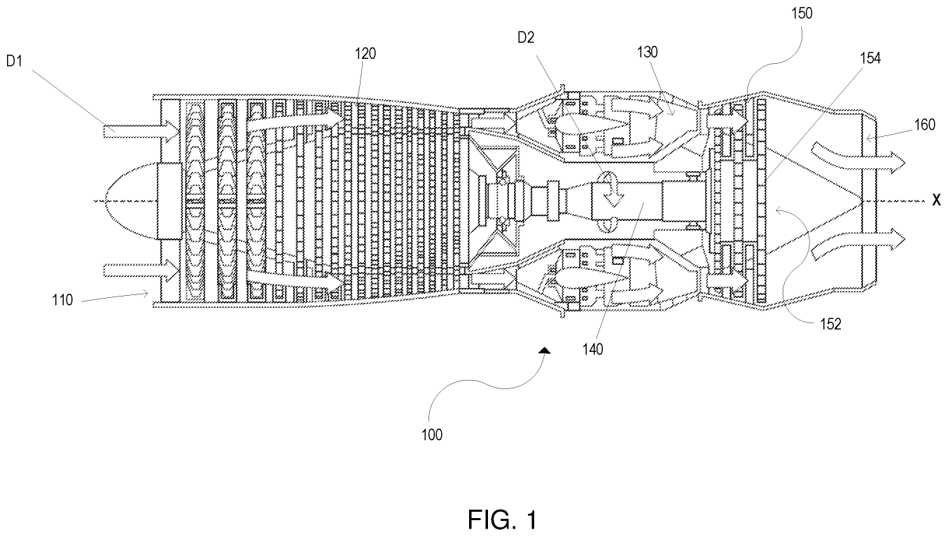

FIG. 1 is a cross-sectional view of a gas turbine engine 100. In some examples, the gas turbine engine 100 may supply power to and/or provide propulsion of an aircraft. Examples of the aircraft may include a helicopter, an airplane, an unmanned aerial vehicle, a fixed wing vehicle, a variable wing vehicle, a rotary wing vehicle, an unmanned combat aerial vehicle, a tailless aircraft, a hover craft, and any other airborne vehicle. Alternatively or in addition, the gas turbine engine 100 may be utilized in a configuration unrelated to an aircraft such as, for example, an industrial application, an energy application, a power plant, a pumping set, a marine application (for example, for naval propulsion), a weapon system, a security system, a perimeter defense or security system.

The gas turbine engine 100 may take a variety of forms in various embodiments. Though depicted as an axial flow engine, in some forms the gas turbine engine 100 may have multiple spools and/or may be a centrifugal or mixed centrifugal/axial flow engine. In some forms, the gas turbine engine 100 may be a turboprop, a turbofan, or a turboshaft engine. Furthermore, the gas turbine engine 100 may be an adaptive cycle and/or variable cycle engine. Other variations are also contemplated.

The gas turbine engine 100 may include an intake section 110, a compressor section 120, a combustion section 130, a shaft 140, a turbine section 150, a turbine 152, turbine blades 154, and an exhaust section 160. During operation of the gas turbine engine 100, fluid received from the intake section 110, such as air, travels along the direction D1 and may be compressed within the compressor section 120. The compressed fluid may then be mixed with fuel and the mixture may be burned in the combustion section 130. The combustion section 130 may include any suitable fuel injection and combustion mechanisms. The hot, high pressure fluid may then pass through the turbine section 110 to extract energy from the fluid and cause a turbine shaft of the turbine 162 in the turbine section 110 to rotate, which in turn drives the compressor section 160. Discharge fluid may exit the exhaust section 160.

As noted above, the hot, high pressure fluid passes through the turbine section 110 during operation of the gas turbine engine 100. As the fluid flows through the turbine section 110, the fluid passes between adjacent blades 154 of the turbine 152 causing the turbine 152 to rotate. The rotating turbine 152 may turn the shaft 140 in a rotational direction D2, for example. The blades 154 may rotate around an axis of rotation, which may correspond to a centerline X of the turbine 152 in some examples.

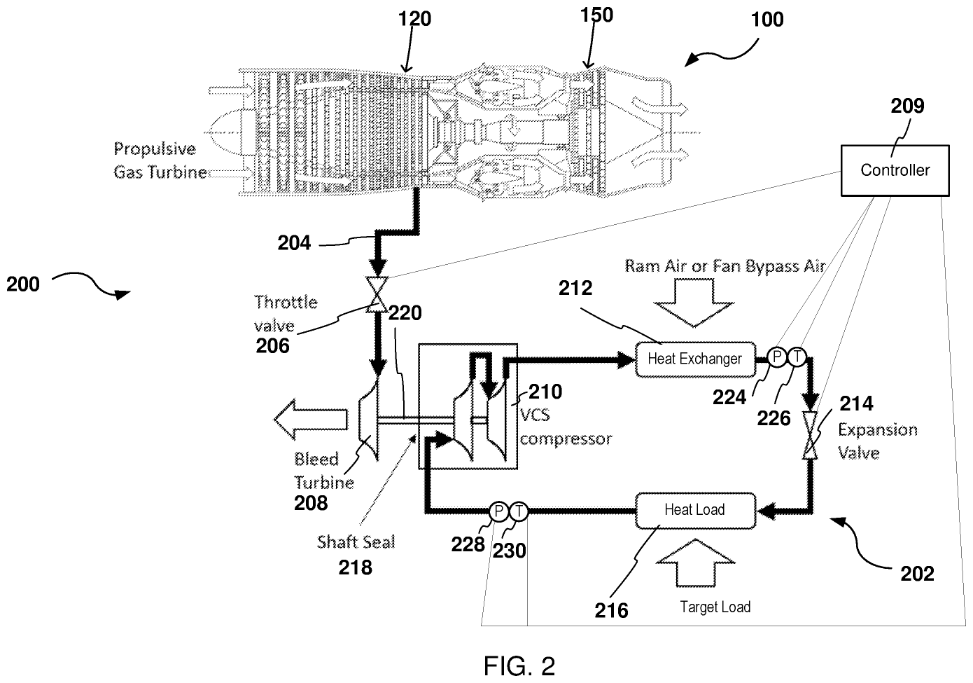

FIG. 2 illustrates a cooling system 200. The cooling system 200 may comprise a gas turbine engine 100, a vapor cycle system (VCS) 202, a bleed air conduit 204, a throttle valve 206, a bleed turbine 208, and a controller 209. The VCS 202 may comprise a compressor 210, a heat exchanger 212, an expansion valve 214, a heat load 216, a shaft seal 218, a shaft 220, pressure sensors 224, 228, and temperature sensors 226, 230.

The bleed air conduit 204 may be any tube, pipe, conduit, and/or other suitable pathway that extends between the gas turbine engine 100 and the bleed turbine 208. For example, as shown in FIG. 2, the bleed air conduit 204 may extend from the compressor section 160 of the gas turbine engine 100 to the bleed turbine 208 such that a bleed air taken from the compressor section 160 is directed and flows to the bleed turbine 208. As discussed below, additionally or alternatively, the bleed air conduit 204 may be connected to other sections of the gas turbine engine 100.

The throttle valve 206 may be any valve capable of controlling and/or changing the speed of a flow of fluid, for example air, flowing through the bleed air conduit 204 by opening or closing of the valve. The throttle valve 206 may be controlled, for example, by the controller 209 based on measurements from the temperature 226 and pressure sensors 224. The throttle valve 206 may be disposed along the bleed air conduit 204 between the gas turbine engine 100 and the bleed turbine 208.

The bleed turbine 208 may any type of turbine or device capable of translating energy, for example, from a flow of fluid into rotational energy and rotating the shaft 220. The bleed turbine 208 may be coupled to an end of the bleed air conduit 204 opposite the gas turbine engine 100. The bleed turbine 208 may receive a discharge, for example, from the compressor section 160 of the gas turbine engine via the bleed air conduit 204, which may rotate the bleed turbine 108. The bleed turbine 208 may be coupled to the shaft 220 such that rotation of the bleed turbine 208 causes the shaft 220 to rotate.

The controller 209 may be any device capable of receiving sensor feedback from the pressure sensors 224, 228 and temperature sensors 226, 230 and transmitting signals to the throttle valve 206 and/or expansion valve 214 accordingly. The controller 209 may include, for example, a processor. The controller 209 may, for example, electrically, mechanically, or otherwise control the valves 206, 214 based on a target temperature, pressure, superheat, subcool, and/or flow rate of the cooling system 200 and/or VCS 202. Examples of the controller 209 may include a processor, programmable logic controller (PLC), a computer, a laptop, a microcontroller, or any other processing device.

The VCS 202 may operate via a vapor compressor and/or vapor compression. The VCS 202 may be a direct expansion, closed-loop vapor cycle system. The VCS 202 may include the compressor 210, the heat exchanger 212, the pressure sensor 224, the temperature sensor 226, the expansion valve 214, the heat load 216, the pressure sensor 228, and the temperature sensor 230. The VCS 202 may be connected to the shaft 220 via the compressor 210.

The compressor 210 may be any device capable of compressing and/or pushing a cooling fluid through the vapor cycle system 202. The compressor 210 may, for example, be a hermetic compressor including a compressor and motor inside. The cooling fluid may be, for example, a liquid, vapor, and/or a liquid-vapor mixture. For example, the cooling fluid may be a two-phase cooling fluid, for example, a two-phase refrigerant. The cooling fluid may be, for example, R134a, R410a, R1234yf, R1234ze, R1233zd, R515, R450a, R452b, R466, or any other suitable refrigerant or cooling fluid.

The compressor 210 may be coupled to the shaft 220, for example, at an opposite end of the shaft 220 from the bleed turbine 208. The compressor 210 and the bleed turbine 208 may be connected via the shaft 220. The compressor 210 may be driven by the bleed turbine 208 via the shaft 220 such that rotation of the shaft 220 from the bleed turbine 208 drives the compressor 210. A shaft seal 218 may be disposed along the shaft 220 between the bleed turbine 208 and the compressor 210. The shaft seal 218 may be, for example, disposed along the shaft 220 between the shaft 220 and a housing of the compressor 210. The seal 218 may be any suitable material to create a seal between the shaft 220 and compressor 210. The seal 218 may minimize leakage of a refrigerant from the compressor 210 into the external environment and/or may minimize a pressure differential or drop across the housing of the compressor 210. The bleed turbine 208 and/or compressor 210 may include multiple stages.

The heat exchanger 212 may be any device capable of transferring and/or absorbing heat from the cooling fluid. For example, the heat exchanger 212 may transfer heat from the cooling fluid to the ambient environment of the VCS 202. For example, the heat exchanger 212 may use a fluid, such as ram air or fan bypass air from the gas turbine engine 100 to absorb heat from the cooling fluid flowing through the VCS 202. The heat exchanger 212 may be, for example, a condenser. The heat exchanger 212 may be, for example, a parallel-flow heat exchanger, a counter flow heat exchanger, a multi-pass flow heat exchanger, and/or a cross flow heat exchanger. The cooling fluid may fill the hot-side channels of the heat exchanger 212 while the ambient environment (for example, air, water, seawater, ram air, fan bypass air) may fill the cold side channels of the heat exchanger 212. The heat exchanger 212 may be disposed downstream of the compressor 210 and upstream of the expansion valve 214. The terms ‘downstream’ and ‘upstream’ may refer to the direction of flow of the cooling fluid in the VCS 202 during normal operation. For example, during normal operation, the cooling fluid flows from the compressor 210, to the heat exchanger 212, to the expansion valve 214, to the heat load 216, and back to the compressor 210.

The pressure sensor 224 and the temperature sensor 226 may be disposed downstream of the heat exchanger 212 and upstream of the expansion valve 214. The pressure sensor 224, the temperature sensor 226 may be connected to and/or in communication with the controller 209 and/or the throttle valve 206. Additionally or alternatively, the cooling system 200 and/or VCS 202 may not have a pressure and/or temperature sensor disposed downstream of the heat exchanger 212 and upstream of the expansion valve 214.

The expansion valve 214 may be any device, orifice, valve, or other structure capable of controlling and/or changing the speed and/or pressure of a flow of fluid, for example, the cooling fluid flowing through the VCS 202, by opening or closing of the valve 214. For example, the expansion valve 214 may simply be an orifice. The expansion valve 214 may be controlled, for example, by a controller 209 based on measurements from the temperature 230 and pressure sensors 228. The expansion valve 214 may be disposed along the VCS 202 between the heat exchanger 212 and the heat load 216.

The heat load 216 may be any device that cools a target load. For example, the heat load 216 may be, for example, a heat exchanger that transfers heat from a target load to the cooling fluid. The heat load 216, for example, may include a heat exchanger, a tube-in-tube heat exchanger, a shell-and-tube heat exchanger, a plate heat exchanger, and/or any similar device. Additionally or alternatively, the heat load 216 may include the target load itself. For example, the heat load 102 and/or target load may include accessory electronics, a generator, an engine, accessory systems such as cabin cooling systems, and/or a discrete component configured to thermally couple to the target load. Additionally or alternatively, a cold plate may be thermally coupled to the target load and may have passages through which the cooling fluid flows and evaporates. The heat load 216 may include a single heat load or it could represent a plurality of heat loads distributed in various series and/or parallel arrangements. The heat load 216 may be disposed downstream of the expansion valve 214 and upstream of the compressor 210. The heat exchanger 212 and/or heat load 216 may include multiple heat exchangers or additional components.

The pressure sensor 228 and the temperature sensor 230 may be disposed downstream of the heat load 216 and upstream of the compressor 210. The pressure sensor 228, the temperature sensor 230 may be connected to and/or in communication with the controller 209 and/or the expansion valve 214. The VCS 202 may include additional components, sensors, and/or heat exchangers.

During operation of the system 200, bleed air from the gas turbine engine 100 may be directed through the bleed air conduit 204. The bleed air may flow from the gas turbine engine 100, through the throttle valve 206, and power the bleed turbine 208. The flow of bleed air may drive the bleed turbine 208, causing the shaft 220 to rotate. Rotation of the shaft 220 from the bleed turbine 208 may drive the compressor 210 of the VCS 202. The bleed air may be discharged from the bleed turbine 208, for example, to the ambient environment. Additionally or alternatively, the bleed air may be discharged to, for example, a cabin of the aircraft and/or to other electronics for cooling.

The compressor 210 may compress the cooling fluid in the VCS 202 and drive a flow of the cooling fluid through the VCS 202. The cooling fluid may flow through the heat exchanger 212. The heat exchanger 212 may absorb heat from the cooling fluid and cool the cooling fluid as it flows through the heat exchanger 212. The cooling fluid may exit the heat exchanger 212 and flow through the expansion valve 214. The cooling fluid may flow from the expansion valve to the heat load 216. The cooling fluid may absorb heat from the heat load 216, cooling the heat load 216 and/or target load. The cooling fluid may flow from the heat load 216 to the compressor 210.

During operation of the system 200, the controller 209 may control the speed and/or capacity of the compressor 210 via the throttle valve 206. For example, the controller 209 may use temperature and/or pressure measurements from the temperature sensor 226 and/or pressure sensor 224 disposed in the VCS 202 to control a degree of opening the throttle valve 206. The temperature sensor 226 and/or pressure sensor 224 may measure the temperature and/or pressure, respectively, of the cooling fluid between the heat exchanger 212 and the expansion valve 214 to determine an amount of subcool coming out the heat exchanger 212 and adjust the compressor 210 accordingly.

For example, if the controller 209 determines, based on feedback from the temperature sensor 226 and/or pressure sensor 224, that the subcool is too low and a greater degree of subcooling is needed, the controller 209 may increase a degree of opening of the throttle valve. Increasing the degree of opening of the throttle valve 206 may cause an increase in flow of the bleed air, an increase in speed of the bleed turbine 208, and an increase in capacity and speed of the compressor 210.

Additionally or alternatively, during operation, the controller 209 may control a degree of opening of the expansion valve 214. For example, the controller 209 may use temperature and/or pressure measurements from the temperature sensor 230 and/or pressure sensor 228 disposed in the VCS 202 to control a degree of opening the expansion valve 214. The temperature sensor 230 and/or pressure sensor 228 may measure the temperature and/or pressure, respectively, of the cooling fluid between the heat load 216 and the compressor 210 to determine an amount of superheat coming out the heat load 216 and adjust the expansion valve 214 accordingly.

For example, if the controller 209 determines, based on feedback from the temperature sensor 230 and/or pressure sensor 228, that the superheat is too high, the controller 209 may increase a degree of opening of the expansion valve 214. Additionally or alternatively, opening the expansion valve 214 may cause a drop in pressure of the cooling fluid. The controller 209 may increase the speed of the compressor 210 to compensate for the drop in pressure.

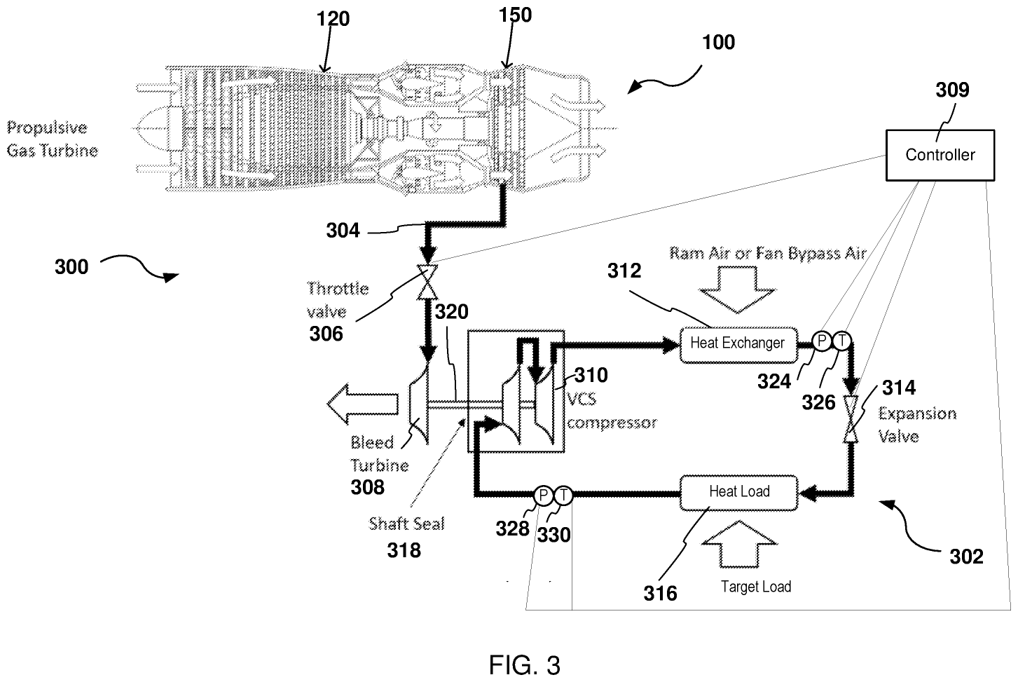

The components in FIGS. 3-5 may be the same, similar, and/or similarly configured as the corresponding components shown in FIG. 2 and described with respect to FIG. 2. For example, the cooling system 300, 400, 500, the VCS 302, 402, 502, the bleed air conduit 304, 404, 504, the throttle valve 306, 506, the bleed turbine 308, 408, 508, the controller 309, 409, 509, the compressor 310, 410, 510, the heat exchanger 312, 412, 512, the expansion valve 314, 414, 514, the heat load 316, 416, 516, the shaft seal 318, 418, 518, the shaft 320, 420, 520, the pressure sensors 324, 328, 424, 428, 524, 528, and the temperature sensors 326, 330, 426, 430, 536, 530 of FIGS. 3-5 may be the same or similarly configured as the cooling system 200, the VCS 202, the bleed air conduit 204, the throttle valve 206, the bleed turbine 208, the controller 209, the compressor 210, the heat exchanger 212, the expansion valve 214, the heat load 216, the shaft seal 218, the shaft 220, the pressure sensors 224, 228, and the temperature sensors 226, 230, respectively, as described with respect to FIG. 2.

FIG. 3 illustrates an example of the cooling system 300 where the bleed air conduit 304 may be coupled to the gas turbine engine 100 at the turbine section 150. Bleed air may be directed from the turbine section 150, through the bleed air conduit 304, through the throttle valve 306, and to the bleed turbine 308. The bleed air from the turbine section 150 may drive the bleed turbine 308. Additionally or alternatively, bleed air may be taken from both the turbine section 120, the compressor section 150, and/or any other sections of the gas turbine engine 100.

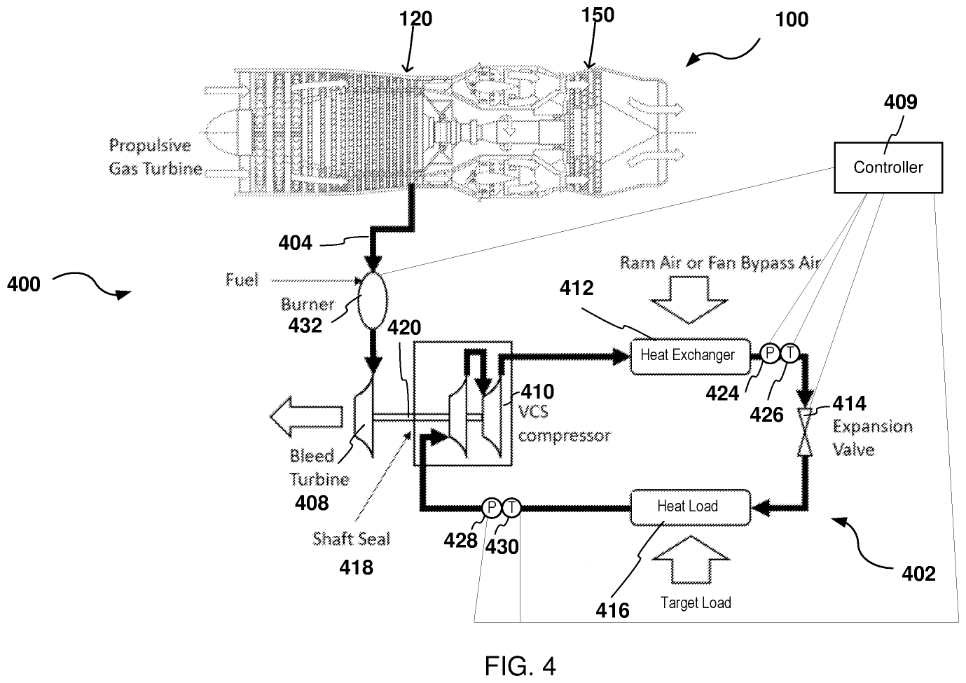

FIG. 4 illustrates an example of the cooling system 400 where the system 400 may further include a burner 432. The burner 432 may be disposed along the bleed conduit 404 between the gas turbine engine 100 and the bleed turbine 408. During operation, the burner 432 may provide additional heat and/or power to the flow of bleed air flowing through the bleed air conduit 404 to increase the cooling capacity of the VCS 402 and/or use less bleed air from the gas turbine engine 100.

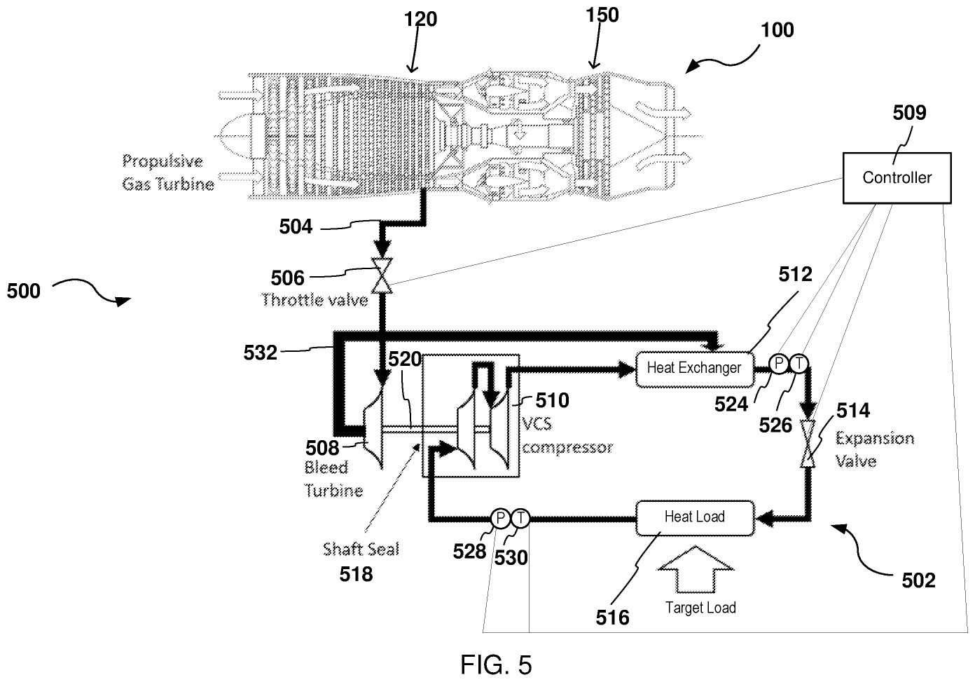

FIG. 5 illustrates an example of the cooling system 500 where the system 500 may further include a discharge conduit 532 coupled to a discharge of the bleed turbine 508 and to the heat exchanger 512. The discharge bleed air from the bleed turbine 508 may be directed through the discharge conduit 532 to the heat exchanger 512. The discharged bleed air may be used to cool the cooling fluid flowing from the compressor 510 to the heat exchanger 512.

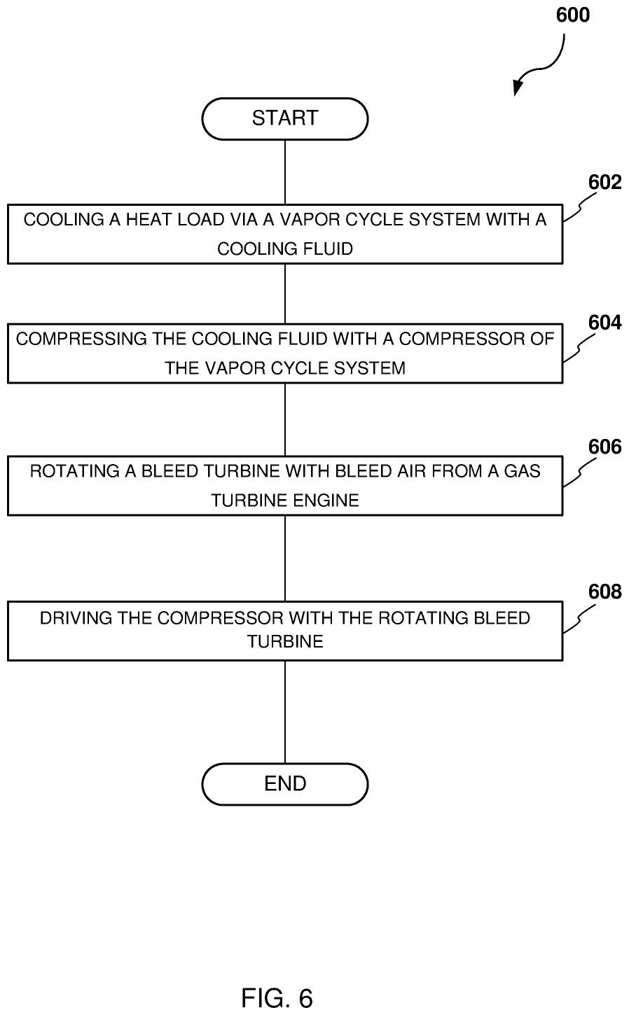

FIG. 6 illustrates an example of step of a method for cooling the heat load 216 (600). The method may include cooling the heat load 216 with a cooling fluid flowing through the VCS 202 (602). The method may include compressing the cooling fluid flowing through the VCS 202 with the compressor 210 (604). The method may include rotating the bleed turbine 208 with bleed air from the gas turbine engine 100 (606). The bleed air may flow to the bleed turbine 208 from the gas turbine engine 100 through the bleed air conduit 204. The method may include driving the compressor 210 with the rotating bleed turbine 208 (608). The bleed turbine 208 may be connected to the compressor 210 via the shaft 220, the rotation of the bleed turbine 208 driving the compressor 210. Additionally or alternatively, the bleed turbine 208 and the compressor 210 may be disposed on separate shafts. For example, the bleed turbine 208 maybe disposed on a first shaft and the compressor 210 disposed on a second shaft. The first and second shafts may be connected via a gearbox, for example, if the bleed turbine 208 and compressor 210 rotate at different speeds.

Each component may include additional, different, or fewer components. The system 200 may be implemented with additional, different, or fewer components. The logic illustrated in the flow diagrams may include additional, different, or fewer operations than illustrated. The operations illustrated may be performed in an order different than illustrated.

Additionally, or alternatively, the controller 222 may include a memory (not shown), a processor (not shown), and a network interface (not shown). The processor may be in communication with the memory and a network interface. The processor and other components of the system 200 may be in communication with each other. Additionally or alternative, the processor may be in communication with one or more sensors. The sensors may be, for example, pressure sensors, flow sensors, and/or temperature sensors. There may be, for example, optical and/or electrical connections between the controller 222 and each one of the components of the system 200 by which the processor and one or more of the components communicate.

In one example, the processor may also be in communication with additional elements, such as a display. Examples of the processor may include a general processor, a central processing unit, a microcontroller, a server, an application specific integrated circuit (ASIC), a digital signal processor, a field programmable gate array (FPGA), a controller, a PLC, and/or a digital circuit, analog circuit.

The processor may be one or more devices operable to execute logic. The logic may include computer executable instructions or computer code embodied in the memory or in other memory that when executed by the processor, cause the processor to perform the features implemented by the logic. The computer code may include instructions executable with the processor.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a cooling system comprising: a vapor cycle system including a compressor, a heat exchanger downstream from the compressor, and a heat load downstream from the heat exchanger and upstream of the compressor; a bleed air conduit configured to receive bleed air from a gas turbine engine; and a bleed turbine driven by the bleed air supplied from the bleed air conduit, the bleed turbine configured to drive the compressor of the vapor cycle system.

A second aspect relates to the cooling system of aspect 1 further comprising an expansion valve, the expansion valve disposed between the heat exchanger and the heat load.

A third aspect relates to the cooling system of any preceding aspect further comprising at least one of a temperature sensor or a pressure sensor disposed downstream of the heat load.

A fourth aspect relates to the cooling system of any preceding aspect further comprising a controller configured to control a degree of opening of the expansion valve based on a measurement of at least one of the temperature sensor or the pressure sensor.

A fifth aspect relates to the cooling system of any preceding aspect wherein the bleed air conduit is coupled to a compressor section of the gas turbine engine.

A sixth aspect relates to the cooling system of any preceding aspect wherein the bleed air conduit is coupled to a turbine section of the gas turbine engine.

A seventh aspect relates to the cooling system of any preceding aspect further comprising a burner, the burner disposed along the bleed air conduit between the gas turbine engine and the bleed turbine.

An eighth aspect relates to the cooling system of any preceding aspect further comprising a discharge conduit, wherein a first end of the discharge conduit is coupled to an outlet of the bleed turbine and a second end of the discharge conduit is coupled to an inlet of the heat exchanger.

A ninth aspect relates to the cooling system of any preceding aspect wherein the heat exchanger is configured to be cooled by ram air or fan bypass air.

A tenth aspect relates to the cooling system of any preceding aspect further comprising a throttle valve, the throttle valve disposed along the bleed air conduit between the gas turbine engine and the bleed turbine.

An eleventh aspect relates to the cooling system of any preceding aspect further comprising at least one of a temperature sensor or a pressure sensor disposed downstream of the heat exchanger.

A twelfth aspect relates to the cooling system of any preceding aspect further comprising a controller configured to control a degree of opening of the throttle valve based on a measurement of at least one of the temperature sensor or the pressure sensor.

A thirteenth aspect relates to a method of cooling a heat load, the method comprising: cooling a heat load via a vapor cycle system with a cooling fluid; compressing the cooling fluid with a compressor of the vapor cycle system; rotating a bleed turbine with bleed air from a gas turbine engine; and driving the compressor with the rotating bleed turbine.

A fourteenth aspect relates to the method of aspect 13 further comprising adjusting a capacity of the compressor by controlling a degree of opening of a throttle valve disposed between the bleed turbine and the gas turbine engine.

A fifteenth aspect relates to the method of any preceding aspect wherein at least one of a temperature sensor or a pressure sensor is disposed downstream of the heat exchanger, the method further comprising adjusting a degree of opening of the throttle valve based on a measurement of at least one of the temperature sensor or the pressure sensor.

A sixteenth aspect relates to the method of any preceding aspect further comprising directing a flow of bleed air to the bleed turbine from a compressor section of the gas turbine engine.

A seventeenth aspect relates to the method of any preceding aspect further comprising directing a flow of bleed air to the bleed turbine from a turbine section of the gas turbine engine.

An eighteenth aspect relates to the method of any preceding aspect further comprising heating a flow of the bleed air with a burner disposed between the bleed turbine and the gas turbine engine.

A nineteenth aspect relates to the method of any preceding aspect wherein a discharge conduit extends between a discharge of the bleed turbine and an inlet of the heat exchanger, the method further comprising cooling a cooling fluid in the vapor cycle system with discharge air from the bleed turbine via the heat exchanger.

A twentieth aspect relates to a system comprising: a gas turbine engine; a vapor cycle system including a compressor connected to a bleed turbine via a shaft, a heat exchanger downstream from the compressor, and a heat load downstream from the heat exchanger and upstream of the compressor; a bleed air conduit configured to receive bleed air from the gas turbine engine; a throttle valve to control a flow of the bleed air through the bleed air conduit; and a bleed turbine driven by the bleed air supplied from the bleed air conduit, the bleed turbine configured to drive the compressor of the vapor cycle system.

In addition to the features mentioned in each of the independent aspects enumerated above, some examples may show, alone or in combination, the optional features mentioned in the dependent aspects and/or as disclosed in the description above and shown in the figures.

1. A cooling system comprising:
a vapor cycle system including
a compressor,
a heat exchanger downstream from the compressor,
a heat load downstream from the heat exchanger and upstream of the compressor, and
at least one of a first temperature sensor or a first pressure sensor disposed between the heat exchanger and the heat load to determine an amount of subcool coming out of the heat exchanger and being delivered to the heat load;
a bleed air conduit configured to receive bleed air from a gas turbine engine;
a bleed turbine driven by the bleed air supplied from the bleed air conduit, the bleed turbine configured to drive the compressor of the vapor cycle system;
a throttle valve disposed along the bleed air conduit between the gas turbine engine and the bleed turbine; and
a controller configured to control a degree of opening of the throttle valve and a flow of a cooling fluid delivered from the compressor to the heat exchanger based on a measurement of at least one of the first temperature sensor or the first pressure sensor.

2. The cooling system of claim 1 further comprising an expansion valve, the expansion valve disposed between the heat exchanger and the heat load.

3. The cooling system of claim 2 further comprising at least one of a second temperature sensor or a second pressure sensor disposed between the heat load and the compressor to determine an amount of superheat coming out of the heat load.

4. The cooling system of claim 3, wherein the controller is configured to control a degree of opening of the expansion valve and a pressure of the cooling fluid being delivered to the heat load from the expansion valve based on a measurement of at least one of the second temperature sensor or the second pressure sensor.

5. The cooling system of claim 1 wherein the bleed air conduit is coupled to a compressor section of the gas turbine engine.

6. The cooling system of claim 1 wherein the bleed air conduit is coupled to a turbine section of the gas turbine engine.

7. The cooling system of claim 1 further comprising a burner, the burner disposed along the bleed air conduit between the gas turbine engine and the bleed turbine.

8. The cooling system of claim 1 further comprising a discharge conduit, wherein a first end of the discharge conduit is coupled to an outlet of the bleed turbine and a second end of the discharge conduit is coupled to an inlet of the heat exchanger.

9. The cooling system of claim 1 wherein the heat exchanger is configured to be cooled by ram air or fan bypass air.

10. (canceled)

11. (canceled)

12. (canceled)

13. A method of cooling a heat load, the method comprising:
cooling a cooling fluid in a vapor cycle system with a heat exchanger;
measuring an amount of subcool coming out of the heat exchanger and being delivered to the heat load with at least one of a first temperature sensor or a first pressure sensor disposed downstream of the heat exchanger;
cooling the heat load via the vapor cycle system with the cooling fluid;
compressing the cooling fluid received from the heat load with a compressor of the vapor cycle system;
rotating a bleed turbine with bleed air from a gas turbine engine;
driving the compressor with the rotating bleed turbine; and
adjusting, with a controller, a degree of opening of a throttle valve disposed between the bleed turbine and the gas turbine engine and a flow of a cooling fluid delivered from the compressor to the heat exchanger based on a measurement of at least one of the first temperature sensor or the first pressure sensor.

14. (canceled)

15. (canceled)

16. The method of claim 13 further comprising directing a flow of bleed air to the bleed turbine from a compressor section of the gas turbine engine.

17. The method of claim 13 further comprising directing a flow of bleed air to the bleed turbine from a turbine section of the gas turbine engine.

18. The method of claim 13 further comprising heating a flow of the bleed air with a burner disposed between the bleed turbine and the gas turbine engine.

19. The method of claim 13, wherein a discharge conduit extends between a discharge of the bleed turbine and an inlet of the heat exchanger, the method further comprising cooling the cooling fluid in the vapor cycle system with discharge air from the bleed turbine via the heat exchanger.

20. A system comprising:
a gas turbine engine;
a vapor cycle system including
a compressor connected to a bleed turbine via a shaft,
a heat exchanger downstream from the compressor,
a heat load downstream from the heat exchanger and upstream of the compressor,
an expansion valve disposed between the heat exchanger and the heat load,
at least one of a first temperature sensor or a first pressure sensor disposed between the heat exchanger and the expansion valve to determine an amount of subcool coming out of the heat exchanger and being delivered to the heat load, and
at least one of a second temperature sensor or a second pressure sensor disposed between the heat load and the compressor to determine an amount of superheat coming out the heat load;
a bleed air conduit configured to receive bleed air from the gas turbine engine;
a throttle valve disposed along the bleed air conduit to control a flow of the bleed air through the bleed air conduit;
a bleed turbine driven by the bleed air supplied from the bleed air conduit, the bleed turbine configured to drive the compressor of the vapor cycle system; and
a controller configured to control a degree of opening of the throttle valve and a flow of a cooling fluid delivered from the compressor to the heat exchanger based on a measurement of at least one of the first temperature sensor or the first pressure sensor, the controller configured to control a degree of opening of the expansion valve and a pressure of the cooling fluid being delivered to the heat load from the expansion valve based on a measurement of at least one of the second temperature sensor or the second pressure sensor.

21. The method of claim 13 further comprising measuring an amount of superheat coming out of the heat load with at least one of a second temperature sensor or a second pressure sensor disposed between the heat load and the compressor.

22. The method of claim 21 further comprising adjusting, with the controller, a degree of opening of the expansion valve and a pressure of the cooling fluid being delivered to the heat load from the expansion valve based on a measurement of at least one of the second temperature sensor or the second pressure sensor.
